(19) United States
(12) Patent Application Publication
(10) Pub. No.: US 2008/0113152 A1
(43) Pub. Date: May 15, 2008

(54) Loop Materials

(75) Inventors: George A. Provost, Litchfield, NH (US); William H. Shepard, Amherst, NH (US)

Correspondence Address: FISH & RICHARDSON PC, P.O. BOX 1022, MINNEAPOLIS, MN, 55440-1022, US

(73) Assignee: VELCRO INDUSTRIES B.V.

(21) Appl. No.: 11/559,556

(22) Filed: Nov. 14, 2006

(51) Int. Cl. B32B 3/06

(52) U.S. Cl. 428/100; 427/173

(57) ABSTRACT

Loop products are provided that include a carrier sheet having a plurality of holes pierced therethrough, a layer of fibers disposed on a first side of the carrier sheet, and a scrim reinforcing layer interposed between the fibers on the first side of the carrier sheet and the carrier sheet. Loops of the fibers extend from the holes on a second side of the carrier sheet, bases of the loops being anchored on the first side of the carrier sheet.

### TECHNICAL FIELD

This invention relates to methods of making sheet-form loop products, particularly by needling fibers into carrier sheets to form loops, and products produced thereby.

### BACKGROUND

Touch fasteners are particularly desirable as fastening systems for lightweight, disposable garments, such as diapers. In an effort to provide a cost-effective loop material, some have recommended various alternatives to weaving or knitting, such as by needling a lightweight layer of fibers to form a light non-woven material that can then be stretched to achieve even lighter basis weight and cost efficiency, with the loop structures anchored by various binding methods, and subsequently adhered to a substrate. U.S. Pat. No. 6,329,016 teaches one such method, for example.

Inexpensive loop materials are desired, for touch fastening and other purposes, with particular characteristics suitable for various applications.

### SUMMARY

In general, the disclosure features loop products in which a scrim reinforcement is interposed between a carrier sheet and a plurality of fibers that are needled through the carrier sheet to form loop structures. The scrim reinforcement provides the loop product with enhanced dimensional stability and tear resistance.

In one aspect, the disclosure features a loop product comprising: (a) a carrier sheet having a plurality of holes pierced therethrough; (b) a layer of fibers disposed on a first side of the carrier sheet, loops of the fibers extending from the holes on a second side of the carrier sheet, bases of the loops being anchored on the first side of the carrier sheet; and (c) a scrim reinforcing layer interposed between the fibers disposed on the first side of the carrier sheet and the carrier sheet.

Some implementations include one or more of the following features. The scrim reinforcing layer comprises a laid scrim. The laid scrim comprises fibers impregnated with a thermosensitive binder, the binder serving to adhere to fibers of the scrim to each other at discrete junctions. The thermosensitive also adheres the scrim layer to at least some of the fibers. The scrim reinforcing layer comprises fibers having a denier of less than 80. The scrim reinforcing layer comprises a 3×6 scrim or a 4×6 scrim. The loop product has an overall weight of less than about 2.0 ounces per square yard (67 grams per square meter). The fibers include bicomponent fibers. The carrier sheet comprises a polymer film. Alternatively, the carrier sheet comprises paper. The loops are configured for releasable engagement by a field of hooks for hook-and-loop fastening.

In another aspect, the disclosure features a method of making a sheet-form loop product, the method comprising (a) placing a scrim reinforcing layer against a first side of a sheet-form substrate; (b) placing a layer of staple fibers against the scrim reinforcing layer, such that the scrim reinforcing layer is interposed between the fibers and the first side of the sheet-form substance; (c) needling fibers of the layer through the substrate and scrim reinforcing layer by piercing the substrate with needles that drag portions of the fibers through holes formed in the substrate during needling, leaving loops of the fibers extending from the holes on a second side of the substrate; and then (d) anchoring fibers forming the loops.

Some implementations of this method include one or more of the following features. The method further comprises selecting and/or positioning the scrim reinforcing layer so as to increase the strength of the product in a cross-machine direction, relative to an otherwise identical product without the scrim reinforcing layer. The method further comprises selecting and/or positioning the scrim reinforcing layer so as to increase the strength of the product in a machine direction, relative to an otherwise identical product without the scrim reinforcing layer. The scrim reinforcing layer comprises a laid scrim. The laid scrim comprises fibers impregnated with a thermosensitive binder, the binder serving to adhere the fibers to each other at discrete junctions. The method further comprises selecting the melting temperature of the thermosensitive binder so that the binder is activated during the anchoring step.

In some implementations, loop materials are provided that are lightweight and low cost, and yet can withstand particularly high shear and peel loads, especially when combined with appropriately sized male fastener elements. The invention can provide loop materials containing surprisingly low basis weights of fiber, and low overall weight and thickness, particularly suitable for low-cycle, disposable products and applications.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic view of a process for forming loop material.

FIGS. 2A-2D are diagrammatic side views of stages of a needing step of the process of FIG. 1. FIG. 2E is a diagrammatic side view showing an elliptical path that may be followed by the needle during needling. The scrim reinforcing layer is omitted in these drawings.

FIG. 3 is an enlarged diagrammatic view of a lamination nip through which the loop material passes during the process of FIG. 1.

FIG. 4 is a highly enlarged diagrammatic view of a loop structure formed by needling with fork needles through film.

FIG. 4A illustrates a loop structure formed by needling with crown needles through polyester film.

FIG. 5 is a diagrammatic view showing an alternative lamination step utilizing a powder-form binder.

FIGS. 6-6C are diagrammatic views of different types of scrims.

### DETAILED DESCRIPTION

Descriptions of loop products will follow a description of some methods of making loop products. In the products, a scrim reinforcing layer is placed on a first side of a carrier sheet, and a layer of fibers is deposited on the scrim reinforcing layer, so that the scrim reinforcing layer is positioned between the fibers and the carrier sheet. The fibers are then needled through the sheet to form loop structure extending from a second side of the sheet, and anchored on the first side of the sheet. This process will now be described in detail.

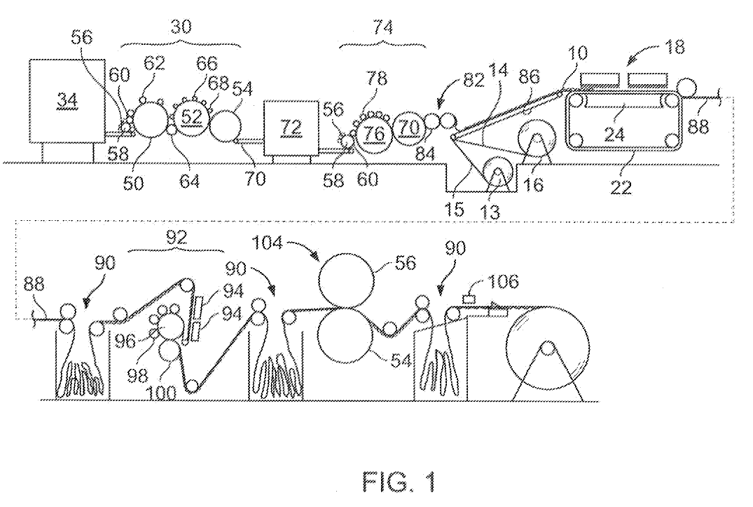

FIG. 1 illustrates a machine and process for producing an inexpensive touch fastener loop product. Beginning at the upper left end of FIG. 1, a carded and cross-lapped layer of fibers 10 is created by two carding stages with intermediate cross-lapping. Weighed portions of staple fibers of different types are fed to the first carding station 30 by a card feeder 34. Card station 30 includes a 36-inch breast roll 50, a 60-inch breaker main 52, and a 50-inch breaker doffer 54. The first card feedroll drive includes 3-inch feedrolls 56 and a 3-inch cleaning roll on a 13-inch lickerin roll 58. An 8-inch angle stripper 60 transfers the fiber to breast roll 50. There are three 8-inch worker roll sets 62 on the breast roll, and a 16-inch breast doffer 64 feeds breaker main 52, against which seven 8-inch worker sets 66 and a flycatcher 68 run. The carded fibers are combed onto a conveyer 70 that transfers the single fiber layer into a cross-lapper 72. Before cross-lapping, the carded fibers still appear in bands or streaks of single fiber types, corresponding to the fibrous balls fed to carding station 30 from the different feed bins. Cross-lapping, which normally involves a 90-degree reorientation of line direction, overlaps the fiber layer upon itself and is adjustable to establish the width of fiber layer fed into the second carding station 74. In this example, the cross-lapper output width is set to approximately equal the width of the carrier into which the fibers will be needled. Cross-lapper 72 may have a lapper apron that traverses a floor apron in a reciprocating motion. The cross-lapper lays carded webs of, for instance, about 80 inches (1.5 meters) in width and about 4 inches (10 centimeters) in thickness, comprising four double layers of carded web. During carding, the fibers are separated and combed into a cloth-like mat consisting primarily of parallel fibers. With nearly all of its fibers extending in the carding direction, the mat has some strength when pulled in the carding direction but almost no strength when pulled in the carding cross direction, as cross direction strength results only from a few entanglements between fibers. During cross-lapping, the carded fiber mat is laid in an overlapping zigzag pattern, creating a mat 10 of multiple layers of alternating diagonal fibers. The diagonal layers, which extend in the carding cross direction, extend more across the apron than they extend along its length.

Cross-lapping the web before the second carding process provides several tangible benefits. For example, it enhances the blending of the fiber composition during the second carding stage. It also allows for relatively easy adjustment of web width and basis weight, simply by changing cross-lapping parameters.

Second carding station 74 takes the cross-lapped mat of fibers and cards them a second time. The feedroll drive consists of two 3-inch feed rolls and a 3-inch cleaning roll on a 13-inch lickerin 58, feeding a 60-inch main roll 76 through an 8-inch angle stripper 60. The fibers are worker by six 8-inch worker rolls 78, the last five of which are paired with 3-inch strippers. A 50-inch finisher doffer 80 transfers the carded web to a condenser 82 having two 8-inch condenser rolls 84, for which the web is combed onto a scrim reinforcing layer 15, fed from a spool 13, which is in turn laid on top of a carrier sheet 14 fed from a spool 16. The condenser increases the basis weight of the web from about 0.7 osy (ounce per square yard) to about 1.0 osy, the reduces the orientation of the fibers to remove directionality in the strength of other properties of the finished product.

The scrim reinforcing layer 15 is typically supplied as a single continuous length, which is fed through the following processing steps with the carrier sheet. Characteristics of suitable scrim materials will be discussed below.

The carrier sheet 14, such as polymer film or paper, may be supplied as a single continuous length, or as multiple, parallel strips. For particularly wide webs, it may be necessary or cost effective to introduce two or more parallel sheets, either adjacent or slightly overlapping. The parallel sheets may be unconnected or joined along a mutual edge. The carded, uniformly blended layer of fibers from condenser 82 is carried up conveyor 86 on carrier sheet 14 and into needling station 18. As the fiber layer enters the needling station, it has no stability other than what may have been imparted by carding and cross-lapping. In other words, the fibers are not pre-needled or felted prior to needling into the carrier sheet. In this state, the fiber layer is not suitable for spooling or accumulating prior to entering the needling station.

In needling station 18, the carrier sheet 14, the scrim reinforcing layer 15, and the fibers are needle-punched from the fiber side. The needles are guided through a stripping plate above the fibers, and draw fibers through the carrier sheet 14 and scrim reinforcing layer 15 to form loops on the opposite side. During needling, the carrier sheet is supported on a bed of pins or bristles extending from a driven support belt or brush apron 22 that moves with the carrier sheet through the needling station. Alternatively, carrier sheet 14 can be supported on a screen or by a standard stitching plate (not shown). Reaction pressure during needling is provided by a stationary reaction plate 24 underlying apron 22. In this example, needling station 18 needles the fiber-covered carrier sheet 14 with an overall penetration density of about 80 to 160 punches per square centimeter. At this needling density and with a carrier sheet of a polypropylene film of a thickness of about 0.0005 inch (0.013 millimeter), we have found that 38 gauge forked tufting needles were small enough to not obliterate the film, leaving sufficient film interconnectivity that the film continued to exhibit some dimensional stability within its plane. With the same parameters, larger 30 gauge needles essentially segmented the film into small, discrete pieces entangled within the fibers. During needling, the thickness of the carded fiber layer only decreases by about half, as compared with felting processes in which the fiber layer thickness decreases by one or more orders of magnitude. As fiber basis weight decreases, needling density may need to be increased.

The needling station 18 may be a “structuring loom” configured to subject the fibers and carrier web to a random velouring process. Thus, the needles penetrate a moving bed of bristles arranged in an array (brush apron 22). The brush apron may have a bristle density of about 2000 to 3000 bristles per square inch (310 to 465 bristles per square centimeter), e.g., about 2570 bristles per square inch (400 per square centimeter). The bristles are each about 0.018 inch (0.46 millimeter) in diameter and about 20 millimeters long, and are preferably straight. The bristles may be formed of any suitable material, for example 6/12 nylon. Suitable brushes may be purchased from Stratosphere, Inc., a division of Howard Brush Co., and retrofitted onto DILO and other random velouring looms. Generally, the brush apron moves at the desired line speed.

Alternatively, other types of structuring looms may be used, for example those in which the needles penetrate into a plurality of lamella or lamellar disks.

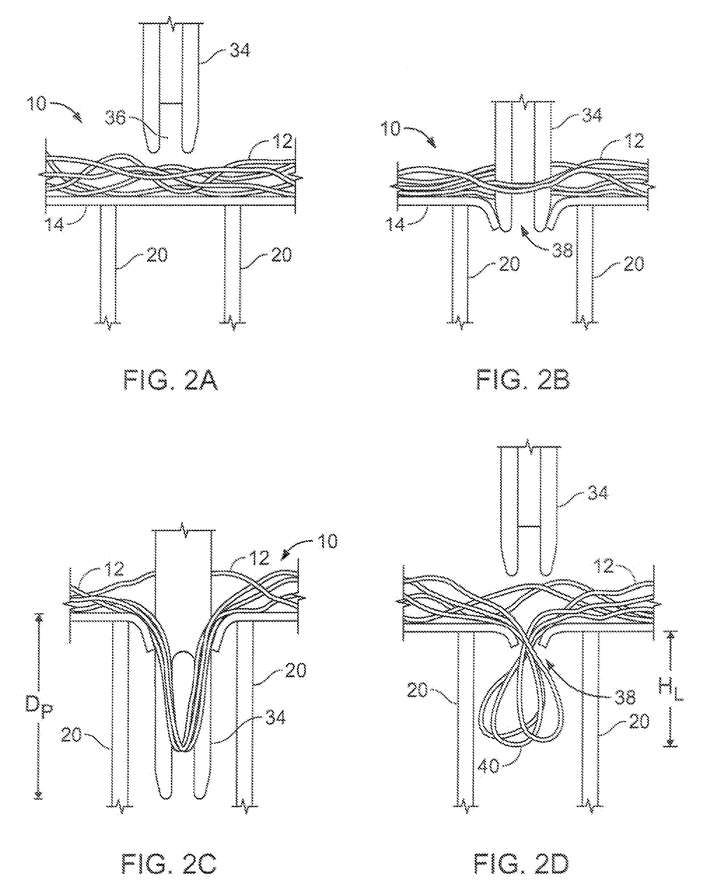

FIGS. 2A through 2D sequentially illustrate the formation of a loop structure by needling. As a forked needle enters the fiber mat 10 (FIG. 2A), some individual fibers 12 will be captured in the cavity 36 in the forked end of the needle. As needle 34 pierces film 14 (FIG. 2B), these captured fibers 12 are drawn with the needle through the hole 38 formed in the film to the other side of the film. As shown, film 14 remains generally supported by pins 20 through this process, the penetrating needle 34 entering a space between adjacent pins. Alternatively, film 14 can be supported by a screen or stitching plate (not shown) that defines holes aligned with the needles. As needle 34 continues to penetrate (FIG. 2C), tension is applied to the captured fibers, drawing mat 10 down against film 14. In this example, a total penetration depth “Dₚ” of about 5.0 millimeters, as measured from the entry surface of film 14, was found to provide a well-formed loop structure without overly stretching fibers in the remaining mat. Excessive penetration depth can draw loop-forming fibers from earlier-formed tufts, resulting in a less robust loop field. Penetration depths of 2 and 7 millimeters also worked in this example, although the 5.0 millimeter penetration is presently preferred. When needle 34 is retracted (FIG. 2D), the portions of the captured fibers 12 carried to the opposite side of the carrier web remain in the form of a plurality of individual loops 40 extending from a common trunk 42 trapped in film hole 38. As shown, residual stresses in the film 14 around the hole, acting to try to restore the film to its planar state, can apply a slight pressure to the fibers in the hole, helping to secure the base of the loop structure. The film can also help to resist tension applied to the fiber remaining on the mat side of the film that would tend to pull the loops back through the hole. The final loop formation preferably has an overall height “H_{L}” of about 0.040 to 0.090 inch (1.0 to 2.3 millimeters), for engagement with the size of male fastener elements commonly employed on disposable garments and such.

Advance per stroke is limited due to a number of constraints, including needle deflection and potential needle breakage. Thus, it may be difficult to accommodate increases in line speed and obtain an economical throughput by adjusting the advance per stroke. As a result, the holes pierced by the needles may become elongated, due to the travel of the carrier sheet while the needle is interacting with the carrier sheet (the “dwell time”). This elongation is generally undesirable, as it reduces the amount of support provided to the base of each of the loop structures by the surrounding substrate, and may adversely affect resistance to loop pull-out. Moreover, this elongation will tend to reduce the mechanical integrity of the carrier film due to excessive drafting, i.e., stretching of the film in the machine direction and corresponding shrinkage in the cross-machine direction.

Elongation of the holes may be reduced or eliminated by causing the needles to travel in a generally elliptical path, viewed from the side. This elliptical path is shown schematically in FIG. 2E. Referring to FIG. 2E, each needle begins at a top “dead” position A, travels downward to pierce the film (position B) and, while it remains in the film (from position B through bottom “dead” position C to position D), moves forward in the machine direction. When the needle has traveled upward sufficiently for its tip to have exited the pierced opening (position D), it continues to travel upward, free of the film while also returning horizontally (opposite to the machine direction) to its normal, rest position (position A), completing the elliptical path. This elliptical path of the needles is accomplished by moving the entire needle board simultaneously in both the horizontal and vertical directions. Needling in this manner is referred to herein as “elliptical needling.” Needling looms that perform this function are available from DILO System Group, Eberbach, Germany, under the tradename “HYPERPUNCH Systems.”

During elliptical needling, the horizontal travel of the needle board is preferably roughly equivalent to the distance that the film advances during the dwell time. The horizontal travel is a function of needle penetration depth, vertical stroke length, carrier film thickness, and advance per stroke. Generally, at a given value of needle penetration and film thickness, horizontal stroke increases with increasing advance per stroke. At a fixed advance per stroke, the horizontal stroke generally increases as depth of penetration and web thickness increases.

For example, for a polypropylene film having a thickness of 0.0005 inch (so thin that it is not taken into account), a loom outfeed of 18.9 m/min, an effective needle density of 15,006 needles/meter, a vertical stroke of 35 mm, a needle penetration of 5.0 mm, and a headspeed of 2,010 strokes/min, the preferred horizontal throw (i.e., the distance between points B and D in FIG. 2E) would be 3.3 mm, resulting in an advance per stroke of 9.4 mm.

Using elliptical needling, it may be possible to obtain line speeds 30 ypm (yards/minute) or mpm (meters/minute) or greater, e.g., 50 ypm or mpm, for example 60 ypm. Such speeds may be obtained with minimal elongation of the holes, for example the length of the holes in the machine direction may be less than 20% greater than the width of the holes in the cross-machine direction, preferably less than 10% greater and in some instances less than 5% greater.

For needling longitudinally discontinuous regions of the material, such as to create discrete loop regions as discussed further below, the needle boards can be populated with needles only in discrete regions, and the needling action paused while the material is indexed through the loom between adjacent loop regions. Effective pausing of the needling action can be accomplished be altering the penetration depth of the needles during needling, including to needling depths at which the needles do not penetrate the carrier sheet. Such needle looms are available from FEHRER AG in Austria, for example. Alternatively, means can be implemented to selectively activate smaller banks of needles within the loom according to a control sequence that causes the banks to be activated only when and where loop structures are desired. Lanes of loops can be formed by a needle loom with lanes of needles separated by wide, needle-free lanes.

In the example illustrated, the needled product 88 leaves needling station 18 and brush apron 22 in an unbonded state, and proceeds to a lamination station 92. If the needling step was performed with the carrier sheet supported on a bed of rigid pins, lamination can be performed with the carrier sheet still carried on the bed of pins. Prior to the lamination station, the web passes over a gamma gage (not shown) that provides a rough measure of the mass per unit area of the web. This measurement can be used as feedback to control the upstream carding and cross-lapping operations. The web is stable enough at this stage to be accumulated in an accumulator 90 between the needling and lamination stations. As known in the art, accumulator 90 is followed by a spreading roll (not shown) that spreads and centers the web prior to entering the next process. Prior to lamination, the web may also pass through a coating station (not shown) in which a binder is applied to enhance lamination. In lamination station 92, the web first passes by one or more infrared heaters 94 that preheat the fibers and/or carrier sheet from the side opposite the loops. In products relying on bicomponent fibers for bonding, heaters 94 preheat and soften the sheaths of the bicomponent fibers. In one example, the heater length and line speed are such that the web spends about four seconds in front of the heaters. Just downstream of the heaters is a web temperature sensor (not shown) that provides feedback to the heater control to maintain a desired web exit temperature. For lamination, the heated web is trained abut a hot can 96 against which four idler card cloth-covered rolls 98 of five inch (13 centimeters) solid diameter (46 centimeters) solid diameter, rotate under controlled pressure. The pins of the card cloth rolls 98, 100 thus press the web against the surface of hot can 96 at discrete pressure points, thus bonding the fibers at discrete locations without crushing fibers, generally between the bond pints, that remain exposed and open for engagement by hooks. For many materials, the bonding pressure between the card cloth rolls and the hot can is quite low, in the range of 1-10 pounds per square inch (70-700 grams per square centimeter) or less. The surface of hot can 96 is maintained at a temperature of about 306 degrees Fahrenheit (150 degrees Celsius) for one example employing bicomponent polyester fiber and polypropylene film, to just avoid melting the polypropylene film. The hot can 96 can have a compliant outer surface, or be in the form of a belt. As an alternative to roller nips, a flatbed fabric laminator (not shown) can be employed to apply a controlled lamination pressure for a considerable dwell time. Such flatbed laminators are available from Glenro Inc. in Paterson, N.J. In some applications, the finished loop product is passed through a cooler (not shown) prior to embossing.

The heating step(s) described above also serves to re-activate the adhesive in the laid scrim, in implementations in which an adhesive-bonded (laid) scrim is utilized as the scrim reinforcing layer 15. When the adhesive is reactivated, it will tend to bond to the fibers 12, adhering the scrim to the fibers and thereby preventing pull-out of the scrim when the loop material is subjected to a tensile force at one end. Depending on the adhesive and carrier sheet that are selected, the adhesive may or may not bond to the carrier sheet.

the pins extending from card cloth-covered rolls 98, 100 are arranged in an array of rows and columns, with a pin density of about 200 and 350 pins per square inch (31 to 54 pins per square centimeter) in a flat state, preferred to be between about 250 to 300 pins per square inch (39 to 47 pins per square centimeter). The pins are each about 0.020 inch (0.5 millimeter) in diameter, and are preferably straight to withstand the pressure required to laminate the web. The pins extend from a backing about 0.25 inch (6.4 millimeters) in thickness. The backing is of two layers of about equal thickness, the lower layer being of fibrous webbing and the upper layer being of rubber. The pins extend about 0.25 inch (6.4 millimeters) from the rubber side of the backing. Because of the curvature of the card cloth rolls, the effective density of the pin tips, where lamination occurs, is lower than that of the pins with the card cloth in a flat state. A flat state pin density of 200 to 350 pins per square inch (31 to 54 pins per square centimeter) equates to an effective pin density of only 22 to 38 pins per square centimeter on idler rolls 98, and 28 to 49 pins per square centimeter on driven rubber roll 100. In most cases, it is preferable that the pins not penetrate the carrier sheet during bonding, but that each pin provide sufficient support to form a robust bond pint between the fibers. In a non-continuous production method, such as for preparing discrete patches of loop material, a piece of carrier sheet 14 and a section of fiber mat 12 may be layered upon a single card cloth, such as are employed for carding webs, for needling and subsequent bonding, prior to removal from the card cloth.

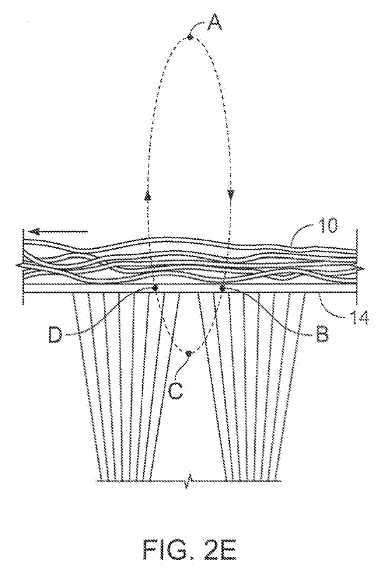

FIG. 3 is an enlarged view of the nip between hot can 96 and one of the card cloth rolls. As discussed above, due to the curvature of the card cloth rolls, their pins 102 splay outward, such that the effective pin density at the hot can is lower than that of the card cloth in a planar state. The pins contact the carrier sheet (or its remnants, depending on needling density) and fuse underlying fibers to each other and/or to material of the carrier sheet, forming a rather solid mass 42 of fused material in the vicinity of the pin tip, and a penumbral area of fused but distinct fibers surrounding each pin. The laminating parameters can be varied to cause these penumbral, partially fused areas to be overlapped if desired, creating a very strong, dimensionally stable web of fused fibers across the non-working side of the loop product that is still sufficiently flexible for many uses. Alternatively, the web can be laminated such that the penumbral areas are distinct and separate, creating a looser web. For most applications the fibers should not be continuously fused into a solid mass across the back of the product, in order to retain a good hand and working flexibility. The number of discrete fused areas per unit area of the bonded web is such that staple fibers with portions extending through holes to form engageable loops 40 that have other portions, such as their ends, secured in one or more of such fused areas 42, such that the fused areas are primarily involved in anchoring the loop fibers against pullout from hook loads. Whether the welds are discrete pints or an interconnected grid, this further secures the fibers, helping to strengthen the loop structures 48. The laminating occurs while the loop structures 28 are safely disposed between pins 102, such that no pressure is applied to crush the loops during bonding. Protecting the loop structures during lamination significantly improves the performance of the material as a touch fastener, as the loop structures remain extended from the base for hook engagement.

If desired, a backing sheet (not shown) can be introduced between the hot can and the needled web, such that the backing sheet is laminate over the back surface of the loop product while the fibers are bonded under pressure from the pins of apron 22.

Referring back to FIG. 1, form lamination station 92 the laminated web moves through another accumulator 90 to an embossing station 104, where a desired pattern of locally raised regions is embossed into the web between two counter-rotating embossing rolls. In some cases, the web may move directly from the laminator to the embossing station, without accumulation, so as to take advantage of any latent temperature increase caused by lamination. The loop side of the bonded loop product is embossed with a desired embossing pattern prior to spooling. In this example the loop product is passed through a nip between a driven embossing roll 54 and a backup roll 56. The embossing roll 54 has a pattern of raised areas that permanently crush the loop formations against the carrier sheet, and may even melt a proportion of the fibers in those areas. Embossing may be employed simply to enhance the texture or aesthetic appeal of the final product. In some cases, roll 56 has a pattern of raised areas that mesh with dimples in roll 54, with corresponding concave regions on the non-working side of the product, such that the embossed product has a greater effective thickness than the pre-embossed product. Additionally, embossing presents the loop structures 48 or otherwise engageable fiber portions at different angles to a mating field of hooks, for better engagement.

The embossed web then moves through a third accumulator 90, past a metal detector 106 that checks for any broken needles or other metal debris, and then is slit and spooled for storage or shipment. During slitting, edges may be trimmed and removed, as can any undesired carrier sheet overlap region necessitated by using multiple parallel strips of carrier sheet.

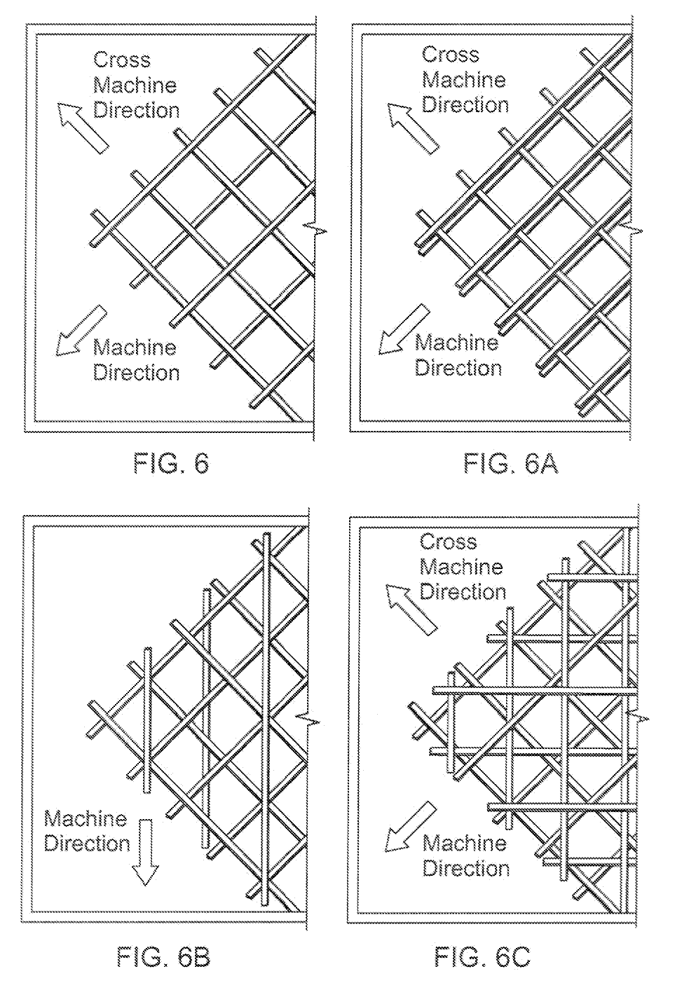

The scrim reinforcing layer 15 may utilize any desired type of scrim, e.g., a laid or woven scrim of any desired fiber type. Generally, laid scrims are preferred. Laid scrims are textile structures in which the weft and warp yarns are linked together by thermosensitive binder, for example a hot melt adhesive. Different types of laid scrims are showed in FIGS. 6-6C, which illustrate, respectively, side-by-side, over/under, tri-directional and quad-directional arrangements. In the side-by-side construction illustrated in FIG. 6, the scrim includes an equal number of wrap and weft yarns, while the over/under arrangement shown in FIG. 6A includes twice as many warp yarns as weft yarns, with pairs of warp yearns being disposed one on either side of the weft yarns. In the tri-and quad-directional arrangements, in addition to the warp and weft yarns, additional yarns are disposed diagonally. Generally, side-by-side constructions are preferred, due to weight and cost constraints. However, for application with higher strength requirements, or applications which require bi-directional reinforcement, other constructions may be preferred.

The scrim may be formed of any desired synthetic or natural fiber that provides desired properties. In some implementations, the scrim is formed of polyester or fiberglass fibers. In some implementation the fibers of the scrim preferably have a denier that is equal to or less than the thickness of the carrier sheet. For example, the fibers of the scrim may have a denier of less than 80, e.g., 70 or less. The fibers may have antimicrobial properties and/or fire resistance if desired.

The scrim may be, for example, a 3×6 scrim or a 4×6 scrim, if reinforcement is required primarily in the cross-machine (A 3×6 scrim has three threads per linear inch in the machine direction and 6 threads per linear inch in the cross-machine direction.) If bi- or multi-directional reinforcement is required other scrims may be more suitable, e.g., a 4×6 or 6×6 scrim. Thus, the number of threads in each direction will depend upon the direction in which most reinforcement is needed. Generally, the denier of the fibers, number of fibers per unit length in each direction, and number of fibers per unit area, can be varied to provide a desired balance of reinforcing properties, weight and cost.

When laid scrims are utilized, it is preferable that the thermosensitive binder used to bond the scrim have an activation temperature that is less than or equal to the temperature of the processing steps to which the fibers 12 will be exposed during post-needling processing (e.g., the bonding/lamination steps described above). This will allow at least some of the fibers to become bonded to the scrim. It is generally preferred that the fibers 12 be bonded to the scrim only to the extent that is needed to keep the scrim from being pulled out in a given application. Excessive bonding between the scrim and fibers 12, e.g., so much that the structure becomes rigid or the scrim becomes embedded, is generally undesirable. Optimal reinforcement is obtained when the scrim, carrier sheet and needled fiber together define a distortable structure, allowing tear loads to be distributed over the scrim. For optimal line speed, it is often preferred that the activation temperature be significantly less than the processing temperature, e.g., for a bonding temperature of 300-350° F. it is preferred that the activation temperature by 250° F. or less.

We have found that, using the process described above, a useful loop product may be formed with relatively little fiber 12. In one example, mat 10 has a basis weight of only about 1.0 osy (33 grams per square meter). Fibers 12 are drawn and crimped polyester fibers, 3 to 6 denier, of about a four-inch (10 centimeters) staple length, mixed with crimped bicomponent polyester fibers of 4 denier and about two-inch (5 centimeters) staple length. The ratio of fibers may be, for example, 80 percent solid polyester fiber to 20 percent bicomponent fiber. In other embodiments, the fibers may include 15 to 30 percent bicomponent fibers. The preferred ratio will depend of the composition of the fibers and the processing conditions. Generally, too little bicomponent fiber may compromise loop anchoring, due to insufficient fusing of the fibers, while too much bicomponent fiber will tend to increase cost and may result in a stiff product and/or one in which some of the loops are adhered to each other. The bicomponent fibers are core/sheath drawn fibers consisting of a polyester core and a copolyester sheath having a softening temperature of about 110 degrees Celsius, and are employed to bind the solid polyester fibers to each other and the carrier.

In this example, both types of fibers are of round cross-section and are crimped at about 7.5 crimps per inch (3 crimps per centimeter). Suitable polyester fibers are available from INVISTA of Wichita, Kans., (www.invista.com) under the designation Type 291. Suitable bicomponent fibers are available from INVISTA under the designation Type 254. As an alternative to round cross-section fibers, fibers of other cross-sections having angular surface aspects, e.g., fibers of pentagon or pentalobal cross-section, can enhance knot formation during needling.

Loop fibers with tenacity values of at least 2.8 grams per denier have been found to provide good closure performance, and fibers with a tenacity of at least 5 or more grams per denier (preferably even 8 or more grams per denier) are even more preferred in many instances. In general terms for a loop-limited closure, the higher the loop tenacity, the stronger the closure. The polyester fibers of mat 10 are in a drawn, molecular oriented state, having been drawn with a draw ratio of at least 2:1 (i.e., to at least twice their original length) under cooling conditions that enable molecular orientation to occur, to provide a fiber tenacity of about 4.8 grams per denier.

The loop fiber denier should be chosen with the hook size in mind, with lower denier fibers typically selected for use with smaller hooks. For low-cycle applications for use with larger hooks and therefore preferably larger diameter loop fibers), fibers of lower tenacity of larger diameter may be employed.

For many application, particularly products where the hook and loop components will be engaged and disengaged more than once (“cycled”), it is desirable that the loops have relatively high strength so that they do not break or tear when the fastener product is disengaged. Loop breakage causes the loop material to have a “fuzzy,” damaged appearance, and widespread breakage can deleteriously effect re-engagement of the fastener.

Loop strength is directly proportional to fiber strength, which is the product of tenacity and denier. Fibers having a fiber strength of at least 6 grams, for example at least 10 grams, provide sufficient loop strength for many applications. Where higher loop strength is required, the fiber strength may be higher, e.g., at least 15. Strengths in these ranges may be obtained by using fibers having a tenacity of about 2 to 7 grams/denier and a denier of about 1.5 to 5, e.g., 2 to 4. For example, a fiber having a tenacity of about 4 grams/denier and denier of about 3 will have a fiber strength of about 12 grams.

Other factors that affect engagement strength and cycling are the geometry of the loop structures, the resistance of the lop structures to pull-out, and the density and uniformity of the loop structures over the surface area of the lop product. The first two of these factors are discussed above. The density and uniformity of the loop structures is determined in part by the coverage of the fibers on the carrier sheet. In other words, the coverage will affect how many of the needle penetrations will result in hook-engageable loop structures. Fiber coverage is indicative of the length of fiber per unit area of the carrier sheet, and is calculated as follows:

Fiber coverage (meters per square meter)=Basis Weight/Denier×9000

Thus, in order to obtain a relatively high fiber coverage at a low basis weight, e.g., less than 2 osy, it is desirable to use relatively low denier (i.e., fine) fibers. However, the use of low denier fibers will require that the fibers have a higher tenacity to obtain a given fiber strength, as discussed above. Higher tenacity fibers are generally more expensive than lower tenacity fibers, so the desired strength, cost and weight characteristics of the product must be balanced to determine the appropriate basis weight, fiber tenacity and denier for a particular application. It is generally preferred that the fiber layer of the loop product have a calculated fiber coverage of at least 50,000, preferably at least 90,000, and more preferably at least 100,000.

To produce loop materials having a good balance of low cost, light weight and good performance, it is generally preferred that the basis weight be less than 2.0 osy, e.g., 1.0 to 2.0 osy, and the coverage be about 50,000 to 200,000.

Various synthetic or natural fibers may be employed. In some applications, wool and cotton may provide sufficient fiber strength. Presently, thermoplastic staple fibers which have substantial tenacity are preferred for making thin, low-cost loop product that has good closure performance when paired with very small molded hooks. For example, polyolefins (e.g., polypropylene or polyethylene), polyester (e.g., polyethylene terephthalate), polyamides (e.g., nylon), acrylics and mixtures, alloys, copolymers and co-extrusions thereof are suitable. Polyester is presently preferred. Fibers having high tenacity and high melt temperature may be mixed with fibers of a lower melt temperature resin. For a product having some electrical conductivity, a small percentage of metal fibers may be added. For instance, loop products of up to about 5 to 10 percent fine metal fiber, for example, may be advantageously employed for grounding or other electrical applications.

In one example, the film 14 is a flown polyethylene, such as is available for bag-making and other packaging applications, e.g., having a thickness of about 0.002 inch (0.05 millimeter). Even thinner films may be employed, with good results. Other suitable films include polyester, polypropylenes, EVA, and their copolymers. Other carrier web materials may be substituted for film 14 for particular applications. For example, fibers may be needle-punched into paper, or fabrics such as non-woven, woven or knit materials, for example lightweight cotton sheets. If paper is used, it may be pre-pasted with an adhesive on the fiber side to help bond the fibers and/or a backing layer to the paper.

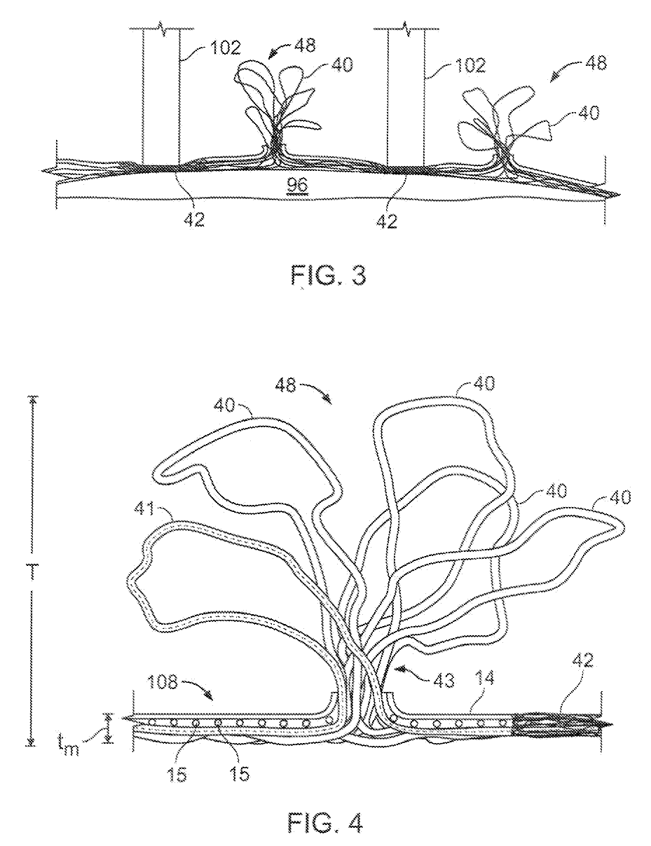

FIG. 4 is an enlarged view of a loop structure 48 containing multiple loops 40 extending from a common trunk 43 through a hole in film 14, as formed by the above-described method. As shown, loops 40 stand proud of the underlying film, available for engagement with a mating hook product, due at least in part to the vertical stiffness of trunk 43 of each formation, which is provided both by the constriction of the film material about the hole and the anchoring of the fibers to each other and the film. This vertical stiffness acts to resist permanent crushing or flattening of the loop structures, which can occur when the loop material is spooled or when the finished product to which the loop material is later joined is compressed for packaging. Resiliency of the trunk 43, especially at its juncture with the base, enables structures 48 that have been “toppled” by heavy crush loads to right themselves when the load is removed. The various loops 40 of formation 48 extend to different heights form the film, which is also believed to promote fastener performance. Because each formation 48 is formed at a site of a penetration of film 14 during needling, the density and location of the individual structures are very controllable. Preferably, there is sufficient distance between adjacent structures so as to enable good penetration of the field of formations by a field of mating male fastener elements (not shown). Each of the loops 40 is of a staple fiber whose ends are disposed on the opposite side of the carrier sheet, such that the loops are each structurally capable of hook engagement. One of the loops 40 in this view is shown as being of a bicomponent fiber 41. The material of the high-tenacity fibers may be selected to be of a resin with a higher melt temperature than the film. After laminating, the film and fibers become permanently bonded together at discrete points 42 corresponding to the distal ends of pins 20.

Because of the relatively low amount of fibers remaining in the mat, together with the thinness of the carrier sheet and any applied backing layer, mat 108 can have a thickness “tₘ” of only about 0.008 inch (0.2 millimeters) or less, preferably less than about 0.005 inch, and even as low as about 0.001 inch (0.025 millimeter) in some cases. The carrier film 14 has a thickness of less than about 0.002 inch (0.05 millimeter), preferably less than about 0.001 inch (0.025 millimeters) and even more preferably about 0.005 inch (0.013 millimeter). The finished loop product 30 has an overall thickness “T” of less than about 0.15 inch (3.7 millimeters), preferably less than about 0.1 inch (2.5 millimeters), and in some cases less than about 0.05 inch (1.3 millimeter). The overall weight of the loop fastener product, including carrier sheet, fibers and fused binder (an optional component, discussed below), is preferably less than about 5 ounces per square yard (167 grams per square meter). For some applications, the overall weight is less than about 2 ounces per square yard (67 grams per square meter), or in one example, about 1.35 ounces per square yard (46 grams per square meter).

Fork needles tend to produce the single-trunk structures as shown in FIG. 4, which we call ‘loop trees. ’ Crown needles, by contrast, tend to create more of a ‘loop brush’ structure, particularly in film carrier sheets. As the barbs of crown needles go through the film, they are more likely to tear the film, perhaps due to increased notch sensitivity. In polyester films, such crown needle film fracturing limits the practical maximum punch density. We have not seen such fracturing in polyethylene, but did observe barb notching. In either case, the film hole created by a crown needle doesn't tend to create the ‘turtleneck’ effect as in FIG. 4, with the result that the fibers passing through the film are not as securely supported. Well-supported loop tress are more able to resist crushing, such as from spooling of the loop material, than less-supported bush structures. Fork needles also tend to create a field of loop structures of more uniform height, whereas felting needles with multiple barb heights tend to create loop structures of more varying loop height. Furthermore, as fork needles wear, they tend to carry more, rather than fewer, loops. Teardrop needles may also be employed, and may reduce the tendency to tear off small ‘chads’ of film that can be formed by fork needles.

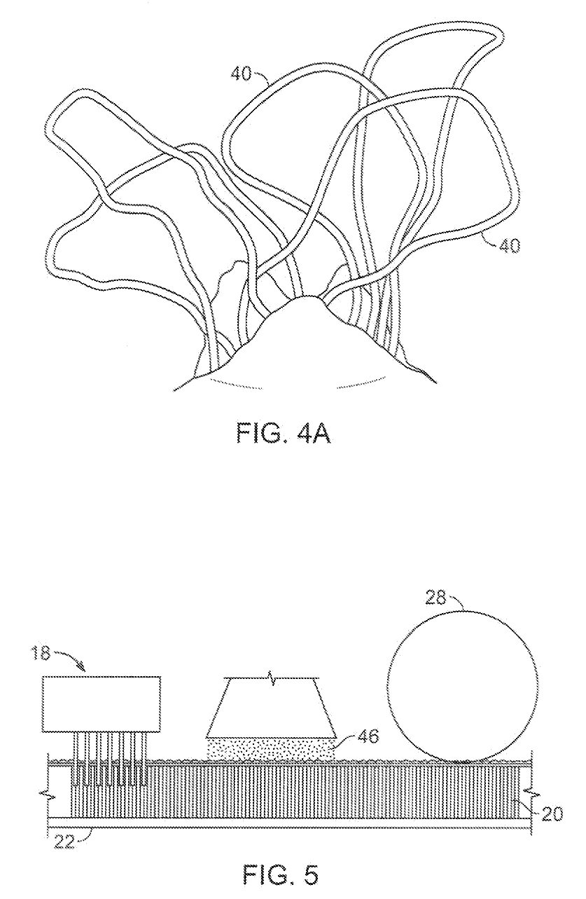

Referring next to FIG. 5, in an alternative lamination step a powdered binder 46 is deposited over the fiber side of the needle-punched film and then fused to the film by roll 28 or a flatbed laminator. For example, a polyethylene powder with a nominal particle size of about 20 microns can be sprinkled over the fiber-layered polyethylene film in a distribution of only about 0.5 ounces per square yard (17 grams per square meter). Such powder is available in either a ground, irregular shape or a generally spherical form from Equistar Chemicals LP in Houston, Tex. Preferably, the powder form and particle size are selected to enable the powder to sift into interstices between the fibers and contact the underlying film. It is also preferable, for many applications, that the powder by of a material with a lower melt temperature than the loop fibers, such that during bonding the fibers remain generally intact and the powder binder fuses to either the fibers or the carrier web. In either case, the powder acts to mechanically bind the fibers to the film in the vicinity of the supporting pins and anchor the loop structures. In sufficient quantity, powder 46 can also form at least a partial backing in the finished loop product, for permanently bonding the loop material onto a compatible substrate. Other powder materials, such as polypropylene or an EVA resin, may also be employed for this purpose, with appropriate carrier web materials, as can mixtures of different powders.

In one test, 3 denier crimped polyester fibers were carded and laid over a scrim reinforcing layer disposed on top of an 0.005 inch (0.013 millimeter) thick sheet of cast polypropylene film in a layer having a basis weight of about 0.5 ounce per square yard (14 grams per square meter). The scrim was a 4×6 laid scrim formed of 70 denier polyester fibers in a side-by-side arrangement as shown in FIG. 6. This scrim is commercially available from St. Gobain Technical Fibers, Grand Island, N.Y., under the designation KSM 4610/P3A-36. The fiber-covered film was then needled with 40 gauge forked needles, from the fiber side, at a needling density of 80 punches per square centimeter, and a penetration depth of 5.0 millimeters. The needled film then passed through a lamination station (lamination station 92, described above) at which it was heated to a temperature of approximately 320° F., reactivating the adhesive in the scrim reinforcing layer.

Mated with a molded hook product with CFM-69 hooks in a density of about 264 hooks per square centimeter from Velcro USA in Manchester, N.H., the loops achieved an average peel of abut 400 grams per inch (160 grams per centimeter), as tested according to ASTM D 5170-91. Mated with this same hook product, the loop material achieved an average shear of about 5,000 grams per square inch (785 grams per square centimeter), as tested according to ASTM D 5169-91. The loop material also exhibited a cross-machine tensile strength of about 4.5 pounds per inch of width.

A number of embodiments of the invention have been described. Nevertheless, it will be understood that various modifications may be made without departing from the spirit and scope of the invention. For example, the loop products described herein may include any of the features described in co-pending U.S. patent application No. 11/102,592; 11/102,455; 11/104,166; 11/102,553 and 11/102,456, all of which were filed on Apr. 8, 2005, the full disclosures of which are incorporated herein by reference. Accordingly, other embodiments are within the scope of the following claims.

What is claimed is:

1. A loop product comprising:
a carrier sheet having a plurality of holes pierced therethrough;
a layer of fibers disposed on a first side of the carrier sheet, loops of the fibers extending from the holes on a second side of the carrier sheet, bases of the loops being anchored on the first side of the carrier sheet; and
a scrim reinforcing layer interposed between the fibers disposed on the first side of the carrier sheet and the carrier sheet.

2. The loop product of claim 1 wherein the scrim reinforcing layer comprises a laid scrim.

3. The loop product of claim 2 wherein the laid scrim comprises fibers impregnated with a thermosensitive binder, the binder serving to adhere the fibers of the scrim to each other at discrete junctions.

4. The loop product of claim 3 wherein the binder also adheres the scrim layer to at least some of the fibers.

5. The loop product of claim 1 wherein the scrim reinforcing layer comprises fibers having a denier of less than 80.

6. The loop product of claim 1 wherein the scrim reinforcing layer comprises a 4×4 scrim or a 2×6 scrim.

7. The loop product of claim 1 wherein the loop product has an overall weight of less than about 2.0 ounces per square yard (67 grams per square meter).

8. The loop product of claim 1 wherein the fibers include bicomponent fibers.

9. The loop product of claim 1 wherein the carrier sheet comprises a polymer film.

10. The loop product of claim 1 wherein the carrier sheet comprises paper.

11. The loop product of claim 1 wherein the loops are configured for releasable engagement by a field of hooks for hook-and-loop fastening.

12. A method of making a sheet-form loop product, the method comprising
placing a scrim reinforcing layer against a first side of a sheet-form substrate;
placing a layer of staple fibers against the scrim reinforcing layer, such that the scrim reinforcing layer is interposed between the fibers and the first side of the sheet-form substrate;
needling fibers of the layer through the substrate and scrim reinforcing layer by piercing the substrate with needles that drag portions of the fibers through holes formed in the substrate during needling, leaving loops of the fibers extending from the holes on a second side of the substrate; and then
anchoring fibers forming the loops.

13. The method of claim 12 further comprising selecting and/or positioning the scrim reinforcing layer so as to increase the strength of the product in a cross-machine direction, relative to an otherwise identical product without the scrim reinforcing layer.

14. The method of claim 12 further comprising selecting and/or positioning the scrim reinforcing layer so as to increase the strength of the product in a machine direction, relative to an otherwise identical product without the scrim reinforcing layer.

15. The method of claim 12 wherein the scrim reinforcing layer comprises a laid scrim.

16. The method of claim 15 wherein the laid scrim comprises fibers impregnated with a thermosensitive binder, the binder serving to adhere the fibers to each other at discrete junctions.

17. The method of claim 16 further comprising selecting the melting temperature of the thermosensitive binder so that the binder is activated during the anchoring step.
